(19) United States
(12) Patent Application Publication
(10) Pub. No.: US 2021/0297751 A1
(43) Pub. Date: Sep. 23, 2021

(54) MANAGING PROGRAM ACCESS DURING PROMOTIONAL PERIOD

(71) Applicant: Sling TV L.L.C., Englewood, CO (US)

(72) Inventors: Seth VanSickel, Parker, CO (US); David Vern Mead, Littleton, CO (US)

(73) Assignee: Sling TV L.L.C., Englewood, CO (US)

(21) Appl. No.: 17/198,548

(22) Filed: Mar. 11, 2021

Related U.S. Application Data
(60) Provisional application No. 62/990,886, filed on Mar. 17, 2020.

(51) Int. Cl. H04N 21/81; H04N 21/234

(52) U.S. Cl. CPC H04N 21/812; H04N 21/8126; H04N 21/8106; H04N 21/23424

(57) ABSTRACT

Devices, systems and processes for managing access to a program during a promotional period are described. A system may include a content system and a user device configured to access the program during the promotion. A content distributor may provide the program to the user device during the promotion. The content system may permit access to the program when the user device satisfies a first technical condition. The first technical condition may specify an end time for the promotion. A second technical condition may specify a start event for the promotion. The content system may permit access to the program during a promotional period defined by the start event and the end time. The end time may be predefined. The start event occurs when the user device communicates an acceptance of the promotion to the content system.

### CROSS REFERENCE TO RELATED APPLICATIONS

This application claims priority to U.S. Provisional Application Ser. No. 62/990,886, filed on Mar. 17, 2020, in the name of inventors Seth VanSickel and David Vern Mead, and entitled “Devices, Systems and Processes for Managing Access to a Program During a Promotional Period”, the entire contents of which are incorporated herein by reference.

### TECHNICAL FIELD

The technology described herein generally relates to devices, systems and processes for managing access to one or more programs during a promotional period.

### BACKGROUND

Today, users may commonly desire access to video content (such as television programs and streaming video programs), audio content (such as streaming music, podcasts, audio books, and the like), on-line gaming content, and other content. Such content, regardless of form is referred to herein as a “program.” Often access to such programs are provided by a “content distributor”. Non-limiting examples of content distributors may include cable systems (such as those provided by COMCAST, COX, and others), satellite systems (such as those provided by DISH, DIRECTV, and others), streaming video systems (such as those provided by SLINGTV, NETFLIX, and others), and others. Typically, a user accesses a program provided by a content distributor using a device, such as a cable box, a satellite receiver, an Internet streaming device, a smartphone, a personal computer, a tablet computing device, or other device (herein, each being a “user device”). Such various forms of user devices are typically configured to request, receive and present (directly or indirectly) one or more programs received and/or otherwise provided by a content distributor.

Typically, a program is provided to a user device under certain contractual terms and conditions. Such contractual terms and conditions (herein, collectively “terms”) are typically set by the content distributor. Once agreed upon, the terms are technologically embodied in one or more configurations and/or settings at one or more of a content distributor's content management system (herein, a “content system”) and/or a user device. Such settings and/or configurations (herein, respectively, “system configurations” and “device configurations”), individually and/or collectively, permit and enable access by a given user device to a given program, provided by a given content distributor, and in accordance with one or more terms. Typically, system configurations and device configurations facilitate user device access to a program on a free basis (during a promotional period) and on a paid basis (during a standard program period). For example, user device access to a program or a selection of program may be provided on a trial or temporary basis. Similarly, access to program(s) on a standard program basis may be provided on a monthly recurring charge basis or otherwise. Settings in system configurations and device configurations typically manage such access to program(s) during both periods.

Further such system configurations and/or device configurations typically require entry, by a user with a content distributor, into one or more terms before any necessary system configurations and device configurations are accomplished. Absent such configuration, user device access to a given program may be prevented.

It is to be appreciated that the common and above described approach may discourage a trial use by a user of a programs provided by a given content distributor. That is, early-adoption by the user thereof of terms to receive certain programs from a content distributor during a promotional period may be discouraged.

Accordingly, devices, systems and processes are needed which facilitate a given user's trial of programs provided by a content distributor during a promotional period. With such trial use desirably resulting in a standard program period. System configuration and/or device configurations which facilitate such trial and early-adoption of the programs during a promotion period, and then during a standard program period are needed. The various embodiments of the present disclosure address these and other non-trivial technical hurdles to provide devices, systems and processes for managing access to a program during promotional and standard program periods.

### SUMMARY

The various embodiments of the present disclosure relate in general to devices, systems and processes for managing access to a program during a promotional period.

In accordance with at least one embodiment of the present disclosure a system for managing access to a program during a promotional period may include a content system. The system may also include a user device, communicatively coupled to the content system. The user device may be configured to access the program during the promotional period. A content distributor may be communicatively coupled to the content system and configured to provide the program to the user device during the promotional period. The content system may be configured to permit access to the program by the user device when the user device satisfies a first technical condition.

For at least one embodiment, the first technical condition may specify an end time for the promotion. For at least one embodiment, a second technical condition may specify a start event for the promotion. The content system may be configured to permit access to the program by the user device during a promotional period defined by the start event and the end time. For at least one embodiment, the end time is predefined. For at least one embodiment, the start event occurs when the user device communicates an acceptance of the promotion to the content system.

For at least one embodiment the content system may further include a processor configured to execute at least one non-transient computer instruction for facilitating a promotional engine. The promotional engine may be configured to generate the first technical condition from a first promotion constraint. The first promotion constraint may be specified by a content distributor operator or a content system operator.

For at least one embodiment, the content system may include a content system processor module configured to execute at least one non-transient computer instruction for facilitating a promotional engine. For at least one embodiment, the promotional engine may be configured to manage the access to the program by the user device by comparing at least one user device configuration setting with each of a first technical condition and a second technical condition. For at least one embodiment, the first technical condition may specify an end time for the promotion. For at least one embodiment, the second technical condition may specify at least one of a quality restriction, a bandwidth requirement, a number of access instance by the user device, and a permitted user device type.

For at least one embodiment, a promotional period during which a user is provided access to a program may begin when the user device satisfies the second technical condition. For at least one embodiment, the promotional engine may be further configured to promote acceptance of a standard programs during the promotional period.

For at least one embodiment, the user device may include a device processor module configured to execute at least one second non-transient computer instruction for facilitating a device promotional engine. For at least one embodiment, the device promotional engine may configure the user device for use during the promotional period.

For at least one embodiment, the content system may include a content system processor module configured to execute at least one non-transient computer instruction for facilitating a promotional engine. The promotional engine may be configured to manage the access to the program by the user device by comparing at least one user device configuration setting with each of the first technical condition and a second technical condition. The first technical condition may specify an end time for the promotion. The second technical condition may specify at least one of a quality restriction, a bandwidth requirement, a number of access instance by the user device, and a permitted user device type.

In accordance with at least one embodiment of the present disclosure a content system may include a processor configured to execute at least one non-transient computer instruction for facilitating a promotional engine. For at least one embodiment, the promotional engine may be configured to manage access to a program by a user device during a promotion by setting at least one system configuration setting in accordance with each of a first technical condition and a second technical condition. For at least one embodiment, the first technical condition may specify an end time for the promotion. For at least one embodiment, the second technical condition may specify at least one of a quality restriction, a bandwidth requirement, a number of access instance by the user device, and a permitted user device type.

For at least one embodiment, the promotional engine may be further configured to manage access to the program, by the user device, during the promotion, by instructing the user device to set at least one device configuration setting in accordance with each specified second technical condition.

For at least one embodiment, the promotion may occur during a promotional period defined by a start time and the end time. For at least one embodiment, the start time may occur when the user device communicates an acceptance of the promotion to the content system.

In accordance with at least one embodiment of the present disclosure, a process for managing access to a program by a user device during a promotion may include the operation determining, by a content system, whether the user device satisfies at least one technical condition for a promotion. For at least one embodiment, when the at least one technical condition is satisfied by the user device, the user device may be permitted to access to a given program. The at least one technical condition for the promotion may specify an end date for the promotion. Access to the given program by the user deice may be permitted by the content system. The content system may be communicatively coupled to the user device and the content system may be configured to execute at least one non-transient computer instruction for facilitating a promotional engine.

For at least one embodiment, the promotion occurs over a promotional period defined by a start time and the end time. The end time may be predefined and the start time may occur when the user device communicates an acceptance of the promotion to the content system. The at least one technical condition may further specify at least one of a quality restriction, a bandwidth requirement, a number of access instance by the user device, and a permitted user device type.

### BRIEF DESCRIPTION OF THE DRAWINGS

The features, aspects, advantages, functions, modules, and components of the devices, systems and processes provided by the various embodiments of the present disclosure are further disclosed herein regarding at least one of the following descriptions and accompanying drawing figures. In the appended figures, similar components or elements of the same type may have the same reference number and may include an additional alphabetic designator, such as 108a-108n, and the like, wherein the alphabetic designator indicates that the components bearing the same reference number, e.g., 108, share common properties and/or characteristics. Further, various views of a component may be distinguished by a first reference label followed by a dash and a second reference label, wherein the second reference label is used for purposes of this description to designate a view of the component. When only the first reference label is used in the specification, the description is applicable to any of the similar components and/or views having the same first reference number irrespective of any additional alphabetic designators or second reference labels, if any.

FIG. 1 is a schematic diagram illustrating a system in which a content system is communicatively coupled to a user device, with both the content system and the user device being configurable for managing access to a program, provided by a content distributor, during a promotional period and in accordance with at least one embodiment of the present disclosure.

FIG. 2 is a flow chart of a process for using a content system and a user device for managing access to a program during a promotional period and in accordance with at least one embodiment of the present disclosure.

### DETAILED DESCRIPTION

The various embodiments described herein are directed to devices, systems and processes for managing access to a program during a promotional period.

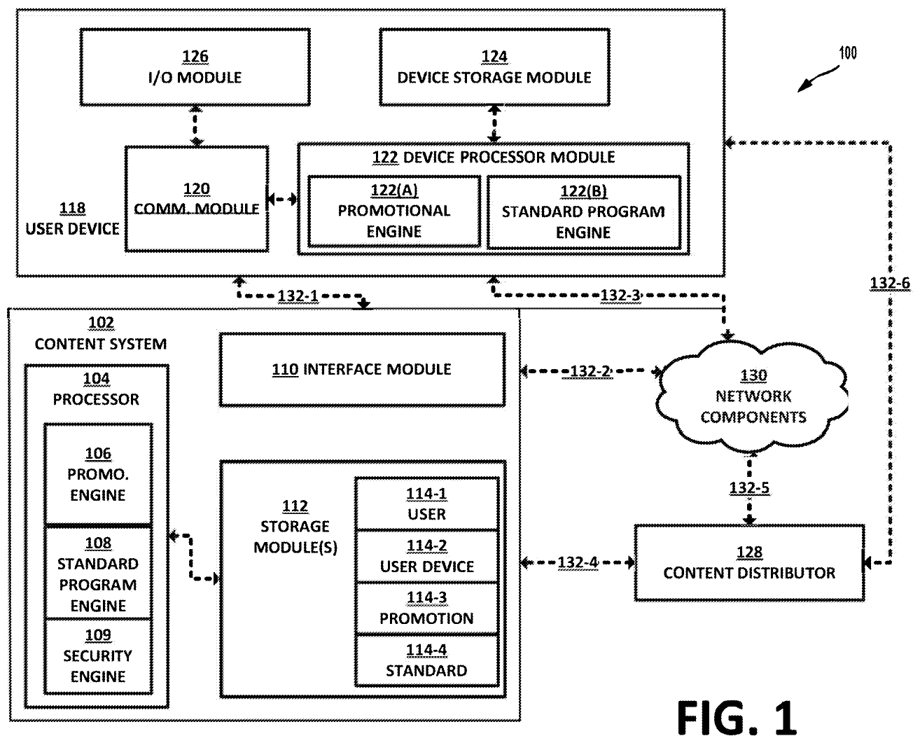

As shown in FIG. 1, for at least one embodiment of the present disclosure, a system 100 for managing access to a program during a promotional period may include a content system 102, a user device 118, a content distributor 128, and one or more network components 130. As described below, the system 100 elements are communicatively coupled via one or more communications links 132. As shown, such communication links may include a first communication link 132-1 coupling the content system 102 directly to the user device 118, a second communication link 132-2 coupling the content system 102 with one or more network components 130, a third communication link 132-3 coupling the one or more network components 130 with the user device 118, a fourth communication link 132-4 coupling the content system 102 with the content distributor 128, a fifth communication link 132-5 coupling the content distributor 128 with the one or more network components 130, and a sixth communication link 132-6 coupling the content distributor 128 with the user device 118. Other configurations of communication link 132 may be used for other embodiments of the present disclosure. One or more of such communications links 132 may be uni-directional, bi-directional, or otherwise configured.

Content System 102:

Processor Module 104

The content system 102 may include one or more content system processor modules 104 configured to provide computer implemented software and hardware engines including, at least, a promotional engine 106, a standard program engine 108, and a security engine 109. Other computer implemented engines may be provided for other embodiments.

The content system processor module 104 may be configured to provide any desired data and/or signal processing capabilities. For at least one embodiment, the content system processor module 104 may have access to one or more non-transitory processor readable instructions, including instructions for executing one or more applications, engines, and/or processes configured to instruct the processor to perform computer executable operations (hereafter, “computer instructions”). The content system processor module 104 may use any known or later arising hardware processor capable of providing and/or supporting the features and functions of the content system 102, as needed for any given intended use thereof and in accordance with one or more of the various embodiments of the present disclosure. As used herein, a reference to a “processor” is a reference to a combination of at least one hardware device, such as a central processing unit, and one or more computer executable instructions executed, in sole or in part, by the at least one hardware device.

For at least one non-limiting embodiment, the content system processor module 104 may be configured as and/or has the capabilities of a 32-bit or 64-bit, multi-core ARM based hardware processor. For at least one embodiment, the content system processor module 104 may arise on one or more backend systems, such as server systems or otherwise. Computer instructions may include firmware and software instructions, and associated data for use in operating the content system 102, as executed by the content system processor module 104. Such computer instructions provide computer executable operations that facilitate one or more features or functions of the content system 102 in accordance with one or more embodiments of the present disclosure. For at least one embodiment, the content system processor module 104 may be configured to implement computer instructions for managing access to a program, as provided by a content distributor 128, during at least one of a promotional period and one or more standard program periods.

Promotional Engine 106

For at least one embodiment, a promotional engine 106 may be executed by the content system processor module 104. For at least one embodiment, the promotional engine 106 is a processor that executes one or more computer instructions with respect to at least one “promotion data set.” As used herein, a “promotion data set” specifies one or more “promotion constraints.” A promotion constraint is a humanly understandable identification of a term associated with a given promotion. Non-limiting examples of promotion constraints may include start and end dates, available program(s) (as identified by, for example, title, producer, channel, or otherwise), and other constraints relating to a given program and/or a given promotion. Promotion constraints may be common to all users and/or user devices or specific with regard to a given user and/or user device, or collection thereof.

Promotion constraints can be converted by the promotional engine into one or more “technical conditions.” Technical conditions are computer settings which govern and can be used by the content system processor module 104 and/or the device processor module 118 to establish one or more system configurations and/or device configurations that facilitate the managing of access to one or more programs during a given promotional period. Non-limiting examples of a technical condition include quality restrictions, bandwidth requirements, access period(s), access times, number of access instances, permitted devices, digital rights management requirements, permitted user device types, and the like. The one or more promotion data sets may be stored in a promotion database 114-3, as further described below. For at least one embodiment, technical conditions may vary by user device, program, promotion, or otherwise.

In at least one embodiment, the promotional engine 106 may be implemented by a dedicated or separate hardware and software processing component configured for use with one or more promotion data sets. The promotional engine 106 may be configured to provide the content system 104 with capabilities of managing access, by a given user device, to at least one program during a promotional period. For at least one embodiment, the promotional period may be defined by a start date and an end date. For at least one embodiment, the start date may vary while the end date is fixed. For at least one embodiment, the start date may be fixed while the end date varies. For at least one embodiment, the promotional period varies based upon when a user requests participation in a given promotion—the date of such user request corresponding to the above mentioned start date. For at least one embodiment, a promotion, and any start and end dates associated therewith, may vary by program or other technical conditions (which are manifestations of one or more terms of a given promotion). Such varying technical conditions may be embodied in the promotion data set, which, when one or more technical conditions are activate (in whole or in part), configure at least one of the content system 102 and the user device 118 to manage access to the given program(s) associated with one or more associated terms of the promotion. Management of access to the given program may include specifying, controlling, granting or restricting access, or otherwise managing a program in terms of such one or more technical conditions.

For at least one embodiment, the promotional engine 106 may be configured to operate in conjunction with a content distributor 128 to facilitate a providing of a given program to a given user device during a given promotional period. The promotional engine 106, working in conjunction with and/or based on data provide by one or more databases provided by a content system storage module 112, such as a user database 114-1, a user device database 114-2, a promotion database 114-3, a standard database 114-4, and/or other databases, may be configured to facilitate management of the providing of a program by a content distributor 128 during promotional periods.

Standard Program Engine 108

For at least one embodiment, the content system processor module 104 may be configured to implement computer instructions for a standard program engine 108. For at least one embodiment, the standard program engine 108 is a processor that executes one or more computer instructions with respect to one or more data sets and in order to manage access to one or more programs during non-promotional/standard periods, such management being technically manifested via system configuration and/or user device configuration pursuant to one or more technical conditions.

In other embodiments, the standard program engine 108 may be implemented by a dedicated or separate processing component. The standard program engine 108 may be configured to provide the content system 104 with capabilities for managing access to one or more programs provided by a content distributor 128. The standard program engine 108, working in conjunction with and/or based on data provide by one or more databases provided by the content system storage module 112, such as the user database 114-1, the user device database 114-2, the promotion database 114-3, the standard database 114-4, and/or other databases, may be configured to facilitate management of the providing of a program by a content distributor 128 during standard program periods.

Security Engine 109

For at least one embodiment, the content system processor module 104 may be configured to implement computer instructions for a security engine 109, such instructions may also and/or alternatively be implemented by a dedicated or separate processing component. The security engine 109 provides the content system 104 with capabilities of securing access to programs, data sets, and otherwise, by the system 100, the user device 118, and other system components. Such secure access may be provided separately during each of the promotional and standard program periods. That is, for at least one embodiment, access to a program may be securely provided separately during a promotional period and separately during a standard program period.

The security engine 109 may be configured to address security needs, including but not limited to, securing the identify of users, securing programs communicated to a user device, facilitating digital rights management of programs, securing access to the content system 102, to a content distributor 128, and/or other security needs. The security engine 109 may operate separately and/or in conjunction with security components provided by other components of the system 100 including those provided by user devices 118, content distributor 128, and network components 130. Any desired know or later arising security technologies, protocols, approaches, schemes, or otherwise may be used in one or more embodiments of the present disclosure.

Interface Module 110

As further shown in FIG. 1 and for at least one embodiment of the present disclosure, a content system 102 may include a content system interface module 110. The content system interface module 110 may include one or more content system-to-device interface modules, content system-to-network interface modules, and/or content system-to-content distributor interface modules. The content system interface module 110 may use any known or later arising technologies for communicatively coupling the content system 102 with one or more user devices 118, the content distributor 128, and/or a network 130 using the one or more communications links 132-1/2/3/4/5/6. Non-limiting examples of such interface modules include hardware and software configured for use with one or more of the BLUETOOTH™, ZIGBEE™, Near Field Communications, Narrowband IOT, WIFI™, 3G, 4G, 5G, cellular, and other currently arising and/or future arising communications technologies. Communication links 132-1/2/3/4/5/6 between the content system 102, the user device 118, the content distributor 128, and/or the network components 130 may be used. Any known or later arising networking and/or other communications technologies, protocols, devices, systems or the like may be used to facilitate communications between content system 102, user device 118, content distributor 128, and network components 130. For at least one embodiment, the content distributor 128 and the content system 102 may be co-located and/or otherwise commonly provided.

For at least one embodiment, the content system interface module 110 may be configured to include one or more data ports for establishing direct and/or indirect connections between the content system 102, the user device 118, and/or the content distributor 128. Such data ports may support any known or later arising technologies, such as USB 2.0™, USB 3.0™, ETHERNET™, FIREWIRE™, HDMI™, wireless technologies, and others. The content system interface module 110 may be configured to support the transfer of data formatted using any desired protocol and at any desired data rates/speeds. The content system interface module 110 may be connected to one or more antennas (not shown) to facilitate wireless data transfers. Such antenna may support short-range technologies, such as 802.11a/c/g/n and others, and/or long-range technologies, such as 4G, 5G, and others. The content system interface module 110 may be configured to communicate signals using terrestrial systems, space-based systems, and combinations thereof.

Storage Module(s) 112 For at least one embodiment, the content system 102 may include one or more content system storage module(s) 112. Computer instructions, data sets and/or other information (collectively herein each a “data set”) may be stored by such content system storage module(s) 112 and used by the content system processor module 104 and/or other system hardware and/or software components to provide one or more features and/or capabilities of the various embodiments of the present disclosure. For example, the content system processor module 104 may be configured to execute, use, implement, modify or otherwise process such stored data sets. It is to be appreciated that the content system storage module(s) 112 (each module and/or sub-division thereof a “storage component”) may be configured using any known or later arising data storage technologies. In at least one embodiment, content system storage module(s) 112 may be configured using flash memory technologies, micro-SD card technology, as a solid-state drive, as a hard drive, as an array of storage devices, or otherwise. Content system storage module(s) 112 may be configured to have any desired data storage size, read/write speed, redundancy, or otherwise. A content system storage module 112 may be configured to provide temporary/transient and/or permanent/non-transient storage of stored data sets, as the case may be. Stored data sets may be encrypted prior to and/or at the time of storage, with decryption of such stored data sets occurring, as needed, for use by processing module, or otherwise.

Content system storage module(s) 112 may include one or more content system databases 114 providing one or more data sets. For at least one embodiment, such content system databases 114 may include a user database 114-1, a user device database 114-2, a promotion database 114-3, and a standard database 114-4. Other databases may be provided for other embodiments.

User Database 114-1

For at least one embodiment, information pertaining to a user may be provided by one or more user data sets stored in a user database 114-1. The storage modules 112 may be configured to collect and provide user data sets for a given user, a collection of users, anonymized users, or otherwise. The user data sets may include any information that may be and/or is useful in managing access to content during a promotion and/or standard program period. Non-limiting examples of such user information may include demographic, psychographic, geographic, or other types of information pertaining to one or more users or collections thereof. The breadth and scope of such types of user information, and the degree of specificity and/or anonymity associated therewith, is not limited and may vary as desired for any given embodiment of the present disclosure. Any source of information may be used in populating one or more user data sets in the user database 114-1. Accordingly, the various embodiments of the present disclosure are not intended to be limited to any given data set or collection, or source thereof, of user information, unless otherwise so expressly recited.

User Device Database 114-2

For at least one embodiment, information pertaining to a given user device 118 may be provided by a user device database 114-2. The storage modules 112 may be configured to collect and provide one or more user device data sets relating to a given user device. The user device data set may include user device information that may be and/or is useful in managing access to a program during one or more of a promotion and a standard program period. Non-limiting examples of such user device information may include device identifier(s) (such as a MAC address), device capabilities, device limitations, location of the user device at a given time, network connection(s) used, and other user device information. Any source of information may be used in populating the one or more user device data sets for a given a user device 118 as maintained in the user device database 114-2. Accordingly, the various embodiments of the present disclosure are not intended to be limited to any given data set or collection, or source thereof, of user device information.

Promotion Database 114-3

For at least one embodiment, a promotion database 114-3 may be configured to collect and provide one or more promotion data sets relating to a given promotion. The promotion database 114-3 may be populated on any desired basis including, but not limited to being populated on a user and/or user device basis. The promotion database may include one or more promotion constraints.

As used herein, a promotion constraint may correspond to a technological condition, which (as defined above) may be used in technologically managing access to one more programs, by a given user device, during a given promotion period. For at least one embodiment, a promotion constraint may also be associated with a term (as defined above). It is to be appreciated that entry of a user device into a promotional period may involve the user both accepting terms (for example, by execution of a click-wrap agreement) as well as one or more system configuration and/or device configurations being established in accordance with the one or more technical conditions associated with a program constraint. For at least one embodiment, the promotion engine 106 may be utilized to manage the performance of such actions by the content system 102, the user device 118 and the content distributor 128 (the latter providing access to the given program after the promotion constraints have been satisfied by agreement of the terms and the setting of the associated technical conditions.

The promotion database 114-3 facilitates the storage of promotion data related to promotions that the promotional engine 106 may utilize to manage the providing of a program during a promotional period. It is to be appreciated, the storage modules 112 in conjunction with the content system processor module 104 may be configured to collectively manage the providing of a program during a promotional period.

Standard Program Database 114-4

For at least one embodiment, a standard program database 114-4 may be configured to facilitate the managing of a program during standard program periods. Such standard program databases are well known in the art and are used, in conjunction with a standard program engine 108, to manage access by a user device to one or more programs during standard (i.e., non-promotional) programming periods.

Other Databases For at least one embodiment of the present disclosure, the storage modules 112 may include the use on a transient or non-transient basis of other databases. The stored data in such other databases being provided for execution and/or use, singularly or collectively, by one or more of the content system 102, user device 118, content distributor 128 and/or one or more networked components 130. Any type of stored data and associated computer instructions implemented for use of such stored data may be provided by such other databases.

User Device

As further shown in FIG. 1, the system 100 includes at least one user device 118. Non-limiting examples of user devices are identified above. The user device 118 may include, amongst other components, a communications module 120, a device processor module 122, a device storage module 124 and a device input/output (I/O) module 126. These modules may be communicatively coupled to each other using any known or later arising intra-device communications components.

Communications Module 120

For at least one embodiment, the user device 118 may include a communications module 120 configured to facilitate communications by and between a user device 118 and one or more of a content system 102, a second user device (not shown), a content distributor 128, and one or more networked components 130. The communications module 120 may include one or more content system interface modules (not shown), content distributor interface modules (not shown) and/or network interface modules (not shown). The communications module 120 may use any known or later arising communications and/or connectivity technologies, as implemented in hardware, software and combinations thereof. Non-limiting examples of such interface modules include hardware and software configured for use with one or more of the BLUETOOTH™, ZIGBEE™, Near Field Communications, Narrowband IOT, WIFI™, 3G, 4G, 5G, cellular, Ethernet, and other currently arising and/or future arising communications technologies.

Device Processor Module 122

For at least one embodiment, a user device 118 may include a device processor module 122. The device processor module 122 may be configured for independent use of the user device 118 and/or assisted use of the user device 118, wherein assisted use involves the off-loading and/or shared processing of one or more computer instructions, data sets, or other information by one or more of a content system 102, a content distributor 128, and/or a networked component 130.

The device processor module 122 may be configured to provide any desired data and/or signal processing capabilities. For at least one embodiment, the device processor module 122 may have access to one or more computer instructions. The device processor module 122 may use any known or later arising hardware processor capable of providing and/or supporting the features and functions of the user device 118, as needed for any given intended use thereof and in accordance with one or more of the various embodiments of the present disclosure. For at least one non-limiting embodiment, the device processor module 122 may be configured as and/or has the capabilities of a 32-bit or 64-bit, multi-core ARM based hardware processor. For at least one embodiment, the device processor module 122 may be configured to operate alone or in conjunction with one or more backend systems, such as server systems or otherwise. Computer instructions may include firmware and software instructions, and associated data for use in operating the user device 118, as executed by the device processor module 122. Such computer instructions provide computer executable operations that facilitate one or more features or functions of the user device 118 and in accordance with one or more embodiments of the present disclosure. For at least one embodiment, the device processor module 122 may be configured to implement computer instructions for managing access to a program, as provided by a content distributor 128, during at least one of a promotional period and one or more standard program periods.

For at least one embodiment, the device processor module 122 may be configured to include one or more computer engines, including a device promotional engine 122(A) and a device standard program engine 122(B). For at least one embodiment, each of the device promotional engine 122(A) and the device standard program engine 122(B) are configured for use in conjunction with, respectively, the promotional engine 106 and the standard program engine 108 to facilitate the managing of access to a program during each of a promotional period and a standard program period.

For at least one embodiment, where stand-alone device operation is to be provided, the device promotional engine 122(A) and the device standard program engine 122(B) may be configured to operate separate and/or independently of one or more of the promotional engine 106 and the standard program engine 108.

For at least one embodiment, the device promotional engine 122(A) may be configured to implement one or more technical conditions associated with a given promotion. Such one or more technical conditions may be unique to the user device 118 or otherwise.

For at least one embodiment, the device standard program engine 122(B) may be configured to use any known or later arising technologies, technical conditions, or the like in furtherance of a managing of a providing of at least one program to a user during a standard program period.

Device Storage Module 124

For at least one embodiment, a user device 118 may include a device storage module 124. The device storage module 124 is a storage component and may be configured using any known or later arising data storage technologies. In at least one embodiment, the device storage module 124 may be configured using flash memory technologies, micro-SD card technology, as a solid-state drive, as a hard drive, as an array of storage devices, or otherwise. The device storage module 124 may be configured to have any desired data storage size, read/write speed, redundancy, or otherwise. The device storage module 124 may be configured to provide temporary/transient and/or permanent/non-transient storage of stored data, as the case may be. Stored data may be encrypted prior to and/or at the time of storage, with decryption of such stored data occurring, as needed, for use by processing module, or otherwise. The device storage module 124 may include one or more collections of data provided by the user database 114-1, the user device database 114-2, the promotion es database 114-3, the standard program database 114-4, and other databases (not shown).

For at least one embodiment, a device storage module 124 may be configured to store one or more user data sets relevant to a given user of a given user device. Such user data set(s) may be generated locally on the user device and/or obtainable from one or more of the beforementioned databases provided by a content system 102. For at least one embodiment, the user data set(s) stored by the device storage module 124 may contain the same, a subset of, and/or different user data than is stored in the user database 114-1.

For at least one embodiment, a device storage module 124 may be configured to store one or more user device data sets relevant to a given user device. Such user device data set(s) may be generated locally on the user device and/or obtainable from one or more of the beforementioned databases provided by a content system 102. For at least one embodiment, the user device data set(s) stored by the device storage module 124 may contain the same, a subset of, and/or different user device data than is stored in the user device database 114-2.

For at least one embodiment, a device storage module 124 may be configured to store one or more promotion data sets relevant to a given promotion. Such promotion data set(s) may be obtained by the user device directly from a content system 102 and/or a content distributor 128. For at least one embodiment, the promotion data set(s) may be obtainable from one or more of the beforementioned databases provided by a content system 102. For at least one embodiment, the promotion data set(s) stored by the device storage module 124 may contain the same, a subset of, and/or different promotion data than is stored in the promotion database 114-3.

For at least one embodiment, a device storage module 124 may be configured to store one or more standard data sets relevant to a given providing of standard programming by a content distributor 128. Such standard data set(s) may be obtained by the user device directly from the content system 102 and/or the content distributor 128. For at least one embodiment, the standard data set(s) may be obtainable from one or more of the beforementioned databases provided by a content system 102. For at least one embodiment, the standard data set(s) stored by the device storage module 124 may contain the same, a subset of, and/or different standard data than is stored in the standard program database 114-4.

Device Position Module (not Shown)

For at least one embodiment, a user device 118 may include a device position module (not shown) configured to identify a position of a given user device 118. For embodiments wherein a given user device is generally non-mobile, such as in the case of the use of a STB in a home or office environment, the device position module may not be utilized, with the location information being already known to a content system 102 or other networked component 130 based upon subscription information, IP address information or other fixed, non-varying indicators of a position of that given user device 118. Contrarily, where a user device 118 is mobile, such as may arise in the use of a smartphone, laptop computer, notebook computer, tablet or other mobile device, an active device position module 125 may be utilized. Such device position module may be configured to use any device position determining technology, including but not limited to, global positioning technologies, IP addressing, user input (e.g., a user inputs their location by use of any user compatible input format), or otherwise. Position information generated and/or captured by a device position module may be utilized by device processor module 122 and, when communicated to, one or more of the content system 102 and the content distributor 128 to manage access to program(s) during promotional periods and standard program periods. For at least one embodiment, a current location of a user device 118 may be used in determining one or more technical conditions to be satisfied before access to a given program is permitted during one or more of a promotional period and a standard program period.

Input/Output Module 126

For at least one embodiment, a user device 118 may include an input/output module 126 configured to support the providing of humanly perceptible signals by and between the user and the user device 118. Humanly perceptible signals may include, but are not limited to, audible signals, visible signals, tactile signals, textual/graphical signals, vibrational signals, and others.

Audio signals may include spoken text, sounds, or any other audible information. Such audible information may include one or more of humanly perceptible audio signals, where humanly perceptible audio signals typically arise between 20 Hz and 20 KHz. For at least one embodiment, the range of humanly perceptible audio signals may be configurable to support an audible range of a given individual user.

The input/output module 126 generally includes hardware and software which supports the input and (as desired) output of audible signals to a user (herein, “audio technologies”). Such audio technologies may include technologies for converting human speech to text, text to speech, translation from a first language to one or more second languages, playback rate adjustment, playback frequency adjustment, volume adjustments and otherwise. Non-limiting examples of audio technologies that may be utilized in the input/output module 126 include Google Voice, SFTranscription, Brightscript, Google Assistant, and others. In at least one embodiment, the input/output module 126 may be configured to use one or more microphones and speakers to capture and present audible information to user. Such one or more microphones and speakers may be provided by a given user device itself or by a device communicatively couple additional audible device component, for example, by earbuds may be communicatively coupled to a smartphone, with the earbuds functioning as the input/output module 126 and capturing and presenting audio sounds to and from a user, while the smartphone functions as a user device 118.

Accordingly, it is to be appreciated that any existing or future arising input/output devices, systems and/or components may be utilized by and/or in conjunction with a user device 118 and in accordance with an embodiment of the present disclosure.

For at least one embodiment, the input/output module 126 may be used to support visible signals. Visible signals may be in any desired form, such as still images, motion images, augmented reality images, virtual reality images and otherwise. Such visible information may include one or more of humanly perceptible visible signals.

For at least one embodiment, the input/output module 126 may also be configured to capture non-humanly visible images, such as those arising in the X-ray, ultra-violet, infra-red or other spectrum ranges. Such non-humanly visible images may be converted, as desired, into humanly visibly perceptible images by one or more of a user device 118, a content system 102, and/or a networked component 130. For at least one embodiment, the input/output module 126 generally includes hardware and software (herein, “visible technologies”) which supports the input by and (as desired) output of visible signals to a user. Such visible technologies may include technologies for converting images (in any spectrum range) into humanly perceptible images, converting content of visible images into a given user's perceptible content, such as by character recognition, translation, playback rate adjustment, playback frequency adjustment, and otherwise.

The input/output module 126 may be configured to use one or more display devices configured to present visible information to user. The input/output module 126 may be configured to use one or more image capture devices, such as those provided by lenses, digital image capture and processing software and the like which may be provided by a given user device itself or by a communicatively coupled additional image capture device component, for example, a remote camera in a vehicle or otherwise. Accordingly, it is to be appreciated that any existing or future arising visual input/output devices, systems and/or components may be utilized by and/or in conjunction with a user device 118 to facilitate the management of access to a program during a promotional period and standard program periods and in furtherance of an embodiment of the present disclosure.

For at least one embodiment, the input/output module 126 may be configured to support the providing of textual information by a user using a user device 118. Such textual information signals may be in any desired language, format, character set, or otherwise. Such textual information may include one or more of humanly perceptible characters, such as letters of the alphabet or otherwise.

For at least one embodiment, the input/output module 126 may also be configured to capture textual information in first form, such as a first language, and convert such textual information into a second form, such as a second language. The input/output module 126 generally includes hardware and software (herein, “textual technologies”) which supports the input by and (as desired) output of textual information signals to a user. Such textual technologies may include technologies for inputting, outputting, and converting textual content into a given user's perceptible content, such as by character recognition, translation, size/font adjustment, and otherwise. In at least one embodiment, the input/output module 126 may be configured for use with an input device, such as a keyboard, touch pad, mouse, or other device to capture textual information. It is to be appreciated that any existing or future arising text input/output devices, systems and/or components may be utilized by and/or in conjunction with a user device 118 to facilitate the use of textual information in the managing of access to a program.

For at least one embodiment, the user device 118 may be configured to support the providing of gesture information, such as sign language, by a user using a user device 118. Such gesture information signals may be in any desired form or format. Such gesture information may include one or more of humanly perceptible characters, such as those provided by sign language. For at least one embodiment, the input/output module 126 may also be configured to capture a user's motions to control one or more aspects of a user device, examples of such motions including those commonly used on smartphone touch interfaces. The input/output module 126 may generally include hardware and software (herein, “gesture technologies”) which supports the input by and (as desired) output of gesture information signals to a user. Such gesture technologies may include technologies for inputting, outputting, and converting gesture content into any given form, such as into textual information, audible information, visual information, device instructions or otherwise.

In at least one embodiment, the input/output module 126 may be configured to use an input device, such as a motion detecting camera, touch pad, mouse, motion sensors, or other devices configured to capture motion information. It is to be appreciated that any existing or future arising gesture input/output devices, systems and/or components may be utilized by and/or in conjunction with a user device 118 to facilitate the use of gesture information in the managing of access to a program.

Content Distributor 128

As shown in FIG. 1, the system 100 may also include one or more content distributors 128. Non-limiting examples of content distributors 128 are described above and are well known in the art.

Networked Components 130

As shown in FIG. 1, the system 100 may also include one or more networked components 130. Non-limiting examples of such networked components include network storage modules, network processor modules, and network support modules.

Network Storage Modules For at least one embodiment, one or more networked storage modules may be communicatively coupled to the content system 102, the content distributor 128, and the user device 118, by one or more direct or indirect connection(s) 132, or combinations thereof. The networked storage modules may be provided via any networked devices and/or systems, such as those communicatively accessible via the Internet, or other networking technologies including but not limited to local, regional, private, public or other networking technologies. It is to be appreciated that the networked storage modules may also be referred to herein as a storage component and, like content system storage modules 112 and device storage modules 124, may be configured using any known or later arising data storage technologies. In at least one embodiment, a network storage module may be configured using flash memory technologies, micro-SD card technology, as a solid-state drive, as a hard drive, as an array of storage devices, or otherwise. A network storage module may be configured to have any desired data storage size, read/write speed, redundancy, or otherwise. A network storage module may be configured to provide temporary/transient and/or permanent/non-transient storage of one or more data sets, computer instructions, and/or other information.

Network Processor Module For at least one embodiment, one or more network processor modules may be configured to execute computer instructions which facilitate in whole, or in part, the managing of access to a program during one or more of a promotional period and a standard program period. Network processor modules may use any known or later arising network and/or server based technologies. Such network processor modules may be configured to support and/or perform, separately and/or in conjunction with one or more of a content system 102, a user device 118, and a content distributor 128 one or more computer instructions utilized in managing access to a program during one or more of a promotional period and a standard program period.

Network Support Module For at least one embodiment, one or more network support modules may be configured to execute computer instructions which facilitate in whole, or in part, the managing of access to a program during one or more of a promotional period and a standard program period. Network support modules may use any known or later arising network and/or server based technologies that facilitate support of the management of program access.

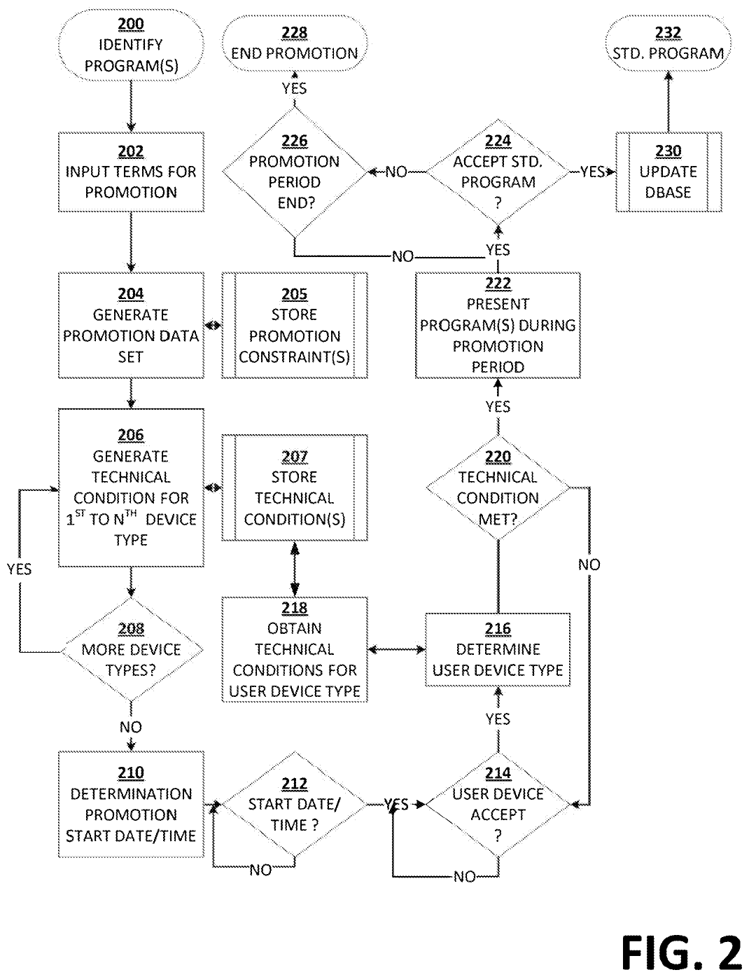

In FIG. 2 and for at least one embodiment of the present disclosure, a process for managing of access to a program during one or more of a promotional period and a standard program period is shown.

Per Operation 200, the process may begin with an identification of one or more programs with respect to which a promotional period is desired. For at least one embodiment, the identification may occur by a content distributor. For another embodiment, the identification may occur by a user device requesting a content distributor to provide promotional access to one or more programs.

Per Operation 202, the process may include inputting by the content distributor one or more terms for a promotion.

Per Operation 204, the process may include generating, by the content system and based on the one or more terms input per Operation 202, a promotion data set which includes one or more promotion constraints.

Per Operation 205, the process may include saving of the promotion data set containing the one or more promotion constraints in a data storage device for later reference, as desired, by either of a content system operator and/or a content distributor operator. For at least one embodiment, such operator(s) may be provided in human and/or artificial intelligent form.

Per Operation 206, the process may include a generating, by the content system, one or more technical conditions for a first device type based on the one or more promotional constraints. For at least one embodiment, the generated technical conditions may vary based on type of user device to be used.

Per Operation 207, the process may include saving of the one or more technical conditions in a data storage device for later reference, as desired, by the content system operator and/or a given user device.

Per Operation 208, the process may include determining whether other (second, third, or the like) user device types are to be supported for the given promotion. If so, Operations 206 and 207 may be repeated until technical conditions for all desired user device types are generated. It is to be appreciated that Operations 206-207 may occur at any time, such as when a new user device type seeks to be provided access to a program during a given promotion.

Per Operation 210, the process may include determining when the given promotion is to begin. For at least one embodiment, a promotion may begin with respect to one or more user devices at a designated start date (which may include a designated start time). For another embodiment, a promotion may begin with respect to a selected first set of user devices at a first start date/time and with respect to a selected second set of user devices at a second start date/time. For example, the first start date/time may specify a U.S. Eastern Standard Time, while the second start date/time may specify a U.S. Mountain Standard Time, or otherwise. For at least one embodiment, a promotion may include a rolling promotion where limited numbers of user devices are allowed to respond at any given time. Such a rolling promotion may be used to minimize overloading of the content system 102, the content distributor 128, the network components 130, or otherwise.

Per Operation 212, the process may include monitoring for a start date/time or other technical condition triggering the start of a promotion with respect to at least one user device. The start date/time may occur, for at least one embodiment, upon a given user device accepting a promotion that the content system may have previously published or otherwise made known to the user device and/or the user thereof.

Per Operation 214, the process may include the monitoring for a given user device acceptance. It is to be appreciated that for at least one embodiment, a start of a promotion may encompass a period extending from the date of a given user accepts the promotion (through corresponding actions and communications occurring between the user's user device 118 vis-à-vis the content system 102) through a designated promotion end date. Per such an embodiment, a first user (as a first adopter) may be provided with a longer promotion period then a second user accepting the given promotion after the first user. For example, a first user accepting on a Monday, the first (1^{st}), a promotion extending through the next Saturday, the sixth (6^{th}), will receive a longer promotional period than a second user accepting that same promotion on the Tuesday, the second (2^{nd})—it being appreciated that the dates and days of the week being arbitrary for this example. By specifying the end date (the 6^{th}) as a technical condition and allowing for a variable start date technical condition, the promotion may be used to encourage early adoption and acceptance of the promotion. Further, other technical conditions may be used instead of a start date, such as a providing of an agreement to access certain user personal data for marketing and other business purposes, a response to a survey, or otherwise.

Per Operation 216, upon acceptance of a promotion by a given user device, the process may include determining the device type for the accepting user device. As discussed above, one or more technical conditions may arise with respect to device types, resolution, digital rights management requirements or otherwise for a given promotion. When such technical conditions are specified, a determination may be made as to whether the given accepting user device satisfies one or more, if not each, of such additional technical conditions.

Per Operation 218, the process may include obtaining the one or more technical conditions specified for a given device type from the data storage populated per Operation 207.

Per Operation 220, the process may include a determination of whether the saved and retrieved technical conditions, for the given device type, satisfy the one or more technical conditions specified for a given promotion. It is to be appreciated that one or more technical conditions for a promotion may vary over time. If the technical condition is not met, the process may return to Operation 214 and the acceptance of the promotion by another user device.

Per Operation 222, the process may include presenting the one or more programs available during the promotional period to the accepting and technical condition(s) compliant user device.

Per Operation 224, the process may include determining whether the user desires to proceed with a standard program arrangement. It is to be appreciated that such option may be presented at any time during or after the promotion period and may be repeatedly presented, as desire for any given implementation of an embodiment of the present disclosure. If “No”, the process may continue with Operation 226. If “Yes”, the process may continue with Operation 320.

Per Operation 226, the process may include determining whether the current promotion period has ended. If “No”, the process may continue with Operation 224. If “Yes”, the process may continue with Operation 228.

Per Operation 228, the process may end with the ending of the promotion period. At this time, the user device participating in the promotion may be configured such that access to the one or more programs provided pursuant to the given promotion are no longer available.

Per Operation 230, the process may include an updating of the standard program database 114-4 when the user selects to receive standard programming (e.g., non-promotional programming). The updating of the database may also include updating of the user device such that system configurations and device configurations are appropriately performed to facilitate the providing of the selected standard programming by the given user device.

Per Operation 232, the process may end with the user device being configured to request, receive and present to a user the standard program(s).

It is to be appreciated that the above process of FIG. 2 provides one non-limiting example of a process that may be used by a content system 102, in conjunction with a user device 118 to manage access to one or more programs during a promotional period and/or one or more standard program periods (which may be indefinite in time). It is to be appreciated that other process steps may be performed and the above described process steps may be performed in different orders of operation, in parallel or serial with respect to one or more user devices, in parallel or serial with respect to one or more programs or otherwise. Accordingly, the various embodiments are not to be limited to any specifically described herein sequence or collection of operations.

Although various embodiments of the claimed invention have been described above with a certain degree of particularity, or with reference to one or more individual embodiments, those skilled in the art could make numerous alterations to the disclosed embodiments without departing from the spirit or scope of the claimed invention. The use of the terms “approximately” or “substantially” means that a value of an element has a parameter that is expected to be close to a stated value or position. However, as is well known in the art, there may be minor variations that prevent the values from being exactly as stated. Accordingly, anticipated variances, such as 10% differences, are reasonable variances that a person having ordinary skill in the art would expect and know are acceptable relative to a stated or ideal goal for one or more embodiments of the present disclosure. It is also to be appreciated that the terms “top” and “bottom”, “left” and “right”, “up” or “down”, “first”, “second”, “next”, “last”, “before”, “after”, and other similar terms are used for description and ease of reference purposes only and are not intended to be limiting to any orientation or configuration of any elements or sequences of operations for the various embodiments of the present disclosure. Further, the terms “coupled”, “connected” or otherwise are not intended to limit such interactions and communication of signals between two or more devices, systems, components or otherwise to direct interactions; indirect couplings and connections may also occur. Further, the terms “and” and “or” are not intended to be used in a limiting or expansive nature and cover any possible range of combinations of elements and operations of an embodiment of the present disclosure. Other embodiments are therefore contemplated. It is intended that all matter contained in the above description and shown in the accompanying drawings shall be interpreted as illustrative only of embodiments and not limiting. Changes in detail or structure may be made without departing from the basic elements of the invention as defined in the following claims.

Further, a reference to a computer executable instruction includes the use of computer executable instructions that are configured to perform a predefined set of basic operations in response to receiving a corresponding basic instruction selected from a predefined native instruction set of codes. It is to be appreciated that such basic operations and basic instructions may be stored in a data storage device permanently and/or may be updateable, but, are non-transient as of a given time of use thereof. The storage device may be any device configured to store the instructions and is communicatively coupled to a processor configured to execute such instructions. The storage device and/or processors utilized operate independently, dependently, in a non-distributed or distributed processing manner, in serial, parallel or otherwise and may be located remotely or locally with respect to a given device or collection of devices configured to use such instructions to perform one or more operations.

What is claimed is:

1. A system comprising:
a content system configured to manage access to a program during a promotion having a promotional period;
a user device, communicatively coupled to the content system, configured to access the program during the promotional period; and
a content distributor, communicatively coupled to the content system, configured to provide the program to the user device during the promotional period; and
wherein the content system is configured to permit access to the program by the user device when the user device satisfies a first technical condition.

2. The system of claim 1,
wherein the first technical condition specifies an end time for the promotion;
wherein a second technical condition specifies a start event for the promotion; and
wherein the content system permits access to the program by the user device during a promotional period defined by the start event and the end time.

3. The system of claim 2,
wherein the end time is predefined.

4. The system of claim 2,
wherein the start event occurs when the user device communicates an acceptance of the promotion to the content system.

5. The system of claim 1,
wherein the content system further comprises:
a processor configured to execute at least one non-transient computer instruction for facilitating a promotional engine; and
wherein the promotional engine is configured to generate the first technical condition from a first promotion constraint.

6. The system of claim 5,
wherein the first promotion constraint is specified by a content distributor operator.

7. The system of claim 5,
wherein the first promotion constraint is specified by a content system operator.

8. The system of claim 1,
wherein the content system further comprises a content system processor module;
wherein the content system processor module is configured to execute at least one non-transient computer instruction for facilitating:
a promotional engine;
wherein the promotional engine is configured to manage the access to the program by the user device by comparing at least one user device configuration setting with each of the first technical condition and a second technical condition;
wherein the first technical condition specifies an end time for the promotion; and
wherein the second technical condition specifies at least one of a quality restriction, a bandwidth requirement, a number of access instance by the user device, and a permitted user device type.

9. The system of claim 8,
wherein the promotional period begins when the user device satisfies the second technical condition; and
wherein the promotional engine is further configured to promote acceptance of a standard programs during the promotional period.

10. The system of claim 1,
wherein the user device further comprises a device processor module;
wherein the device processor module is configured to execute at least one second non-transient computer instruction for facilitating:
a device promotional engine which configures the user device for use during the promotional period by satisfying the first technical condition.

11. The system of claim 10,
wherein the content system further comprises a content system processor module;
wherein the processor is configured to execute at least one non-transient computer instruction for facilitating:
a promotional engine;
wherein the promotional engine is configured to manage the access to the program by the user device by comparing at least one user device configuration setting with each of the first technical condition and a second technical condition;
wherein the first technical condition specifies an end time for the promotion; and
wherein the second technical condition specifies at least one of a quality restriction, a bandwidth requirement, a number of access instance by the user device, and a permitted user device type.

12. A content system comprising:
a processor configured to execute at least one non-transient computer instruction for facilitating a promotional engine;
wherein the promotional engine is configured to manage access to a program by a user device during a promotion by setting at least one system configuration setting in accordance with each of a first technical condition and a second technical condition;
wherein the first technical condition specifies an end time for the promotion; and
wherein the second technical condition specifies at least one of a quality restriction, a bandwidth requirement, a number of access instance by the user device, and a permitted user device type.

13. The content system of claim 12,
wherein the promotional engine is further configured to manage access to the program, by the user device, during the promotion, by instructing the user device to set at least one device configuration setting in accordance with each specified second technical condition.

14. The content system of claim 12,
wherein the promotion occurs during a promotional period defined by a start time and the end time.

15. The content system of claim 14,
wherein the start time occurs when the user device communicates an acceptance of the promotion to the content system.

16. A process, for managing access to a program during a promotion, comprising:
determining, by a content system, whether a user device satisfies at least one technical condition for a promotion; and
when the at least one technical condition is satisfied by the user device, permitting the user device to access to a given program.

17. The process of claim 16,
wherein the at least one technical condition for the promotion specifies an end date for the promotion; and
wherein access to the given program is permitted by the content system;
wherein the content system is communicatively coupled to the user device; and
wherein the content system is configured to execute at least one non-transient computer instruction for facilitating a promotional engine.

18. The process of claim 17,
wherein the promotion occurs over a promotional period defined by a start date and the end date.

19. The process of claim 18,
wherein the end date is predefined; and
wherein the start time occurs when the user device communicates an acceptance of the promotion to the content system.

20. The process of claim 19,
wherein the at least one technical condition further specifies at least one of a quality restriction, a bandwidth requirement, a number of access instance by the user device, and a permitted user device type.
